(19) United States
(12) Patent Application Publication
(10) Pub. No.: US 2026/0135315 A1
(43) Pub. Date: May 14, 2026

(54) Terminal and Terminal Manufacturing Method

(71) Applicant: Tyco Electronics (Shanghai) Co., Ltd., Shanghai (CN)

(72) Inventors: Daiqiong (Diana) Zhang, Shanghai (CN); Zhongxi Huang, Shanghai (CN); Gino (Liqiang) Yao, Shanghai (CN); Yingchun (David) Wang, Shanghai (CN); Yong (Chris) Wang, Shanghai (CN)

(73) Assignee: Tyco Electronics (Shanghai) Co., Ltd., Shanghai (CN)

(21) Appl. No.: 19/388,328

(22) Filed: Nov. 13, 2025

(30) Foreign Application Priority Data
Nov. 14, 2024 (CN) 202411630940.9

(51) Int. Cl. H01R 13/03; H01R 43/16

(52) U.S. Cl. CPC H01R 13/03; H01R 43/16

(57) ABSTRACT

A terminal includes a terminal body, a first bottom plating layer and a first silver graphite plating layer. The terminal body includes a mating part adapted to mate with a mating terminal. The first bottom plating layer is formed on a contact surface of the mating part of the terminal body. The first silver graphite plating layer is formed on the first bottom plating layer. Graphite particles are uniformly dispersed in the first silver graphite plating layer and are adapted to improve the wear resistance and conductivity of the mating part of the terminal body.

### CROSS-REFERENCE TO RELATED APPLICATION

This application claims the benefit of Chinese Patent Application No. CN202411630940.9 filed on Nov. 14, 2024 in the State Intellectual Property Office of China, the whole disclosure of which is incorporated herein by reference.

### FIELD OF THE INVENTION

The disclosure relates to a terminal and a terminal manufacturing method.

### BACKGROUND OF THE INVENTION

In the prior art, traditional power terminals and signal terminals generally use ordinary silver plating methods, with a silver plating layer on their surface. However, the silver plating layer has defects such as poor wear resistance and high insertion and extraction resistance, which results in the insertion and extraction times of ordinary silver plated terminals usually only reaching a few dozen times, at most only a few hundred times. However, in certain application fields, frequent plugging and unplugging of terminals is required, with the number of times the terminals need to be plugged and unplugged reaching thousands or even hundreds of thousands of times. Ordinary silver plated terminals can no longer meet this demand.

In addition, due to the poor wear resistance of ordinary silver plating layers, after multiple insertions and removals, the plating layer of ordinary silver plated terminals will suffer severe wear, and even the plating layer may peel off, exposing the substrate of the terminal. The exposed terminal substrate will be oxidized and corroded, which will increase the contact resistance between the terminal and the mating terminal. When powered on, it will generate excessive heat, and in extreme cases, it may cause fire accidents.

### SUMMARY OF THE INVENTION

According to an embodiment of the present disclosure, a terminal includes a terminal body, a first bottom plating layer and a first silver graphite plating layer. The terminal body includes a mating part adapted to mate with a mating terminal. The first bottom plating layer is formed on a contact surface of the mating part of the terminal body. The first silver graphite plating layer is formed on the first bottom plating layer. Graphite particles are uniformly dispersed in the first silver graphite plating layer and are adapted to improve the wear resistance and conductivity of the mating part of the terminal body.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative view of a terminal body according to a first embodiment of the present invention;

FIG. 2 shows an illustrative view of a terminal according to the first embodiment of the present invention;

FIG. 3 shows a partially enlarged illustrative view of the mating part of the terminal according to the first embodiment of the present invention;

FIG. 4 shows a partially enlarged illustrative view of the crimping part of the terminal according to the first embodiment of the present invention;

FIG. 5 shows an illustrative view of a terminal, a mating terminal, and a cable conductor according to the first embodiment of the present invention, wherein the mating part of the terminal is mated with the mating terminal, and the crimping part of the terminal is crimped onto the cable conductor;

FIG. 6 shows an illustrative view of a terminal body according to a second embodiment of the present invention;

FIG. 7 shows an illustrative view of a terminal according to the second embodiment of the present invention;

FIG. 8 shows a partially enlarged illustrative view of the mating part of the terminal according to the second embodiment of the present invention;

FIG. 9 shows a partially enlarged illustrative view of the crimping part of the terminal according to the second embodiment of the present invention; and

FIG. 10 shows an illustrative view of a terminal, mating terminal, and cable conductor according to a second embodiment of the present invention, wherein the mating part of the terminal is mated with the mating terminal, and the crimping part of the terminal is crimped onto the cable conductor.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal comprises a terminal body which has a mating part for mating with a mating terminal. A first bottom plating layer is formed on a contact surface of the mating part of the terminal body and a first silver graphite plating layer is formed on the first bottom plating layer. Graphite particles are uniformly dispersed in the first silver graphite plating layer to improve the wear resistance and conductivity of the mating part of the terminal body.

According to another embodiment, a terminal manufacturing method comprises the steps of: providing a terminal body; forming a first bottom plating layer on a contact surface of a mating part of the terminal body for mating with a mating terminal; forming a first silver alloy plating layer on the first bottom plating layer; forming a first silver graphite plating layer on the first silver alloy plating layer; and forming a second silver alloy plating layer on the first silver graphite plating layer.

According to another embodiment of the present disclosure, a terminal manufacturing method comprising the steps of: providing a terminal body; forming a first bottom plating layer on a contact surface of a mating part of the terminal body for mating with a mating terminal; and forming a first silver graphite plating layer on the first silver alloy plating layer.

### FIRST EMBODIMENT

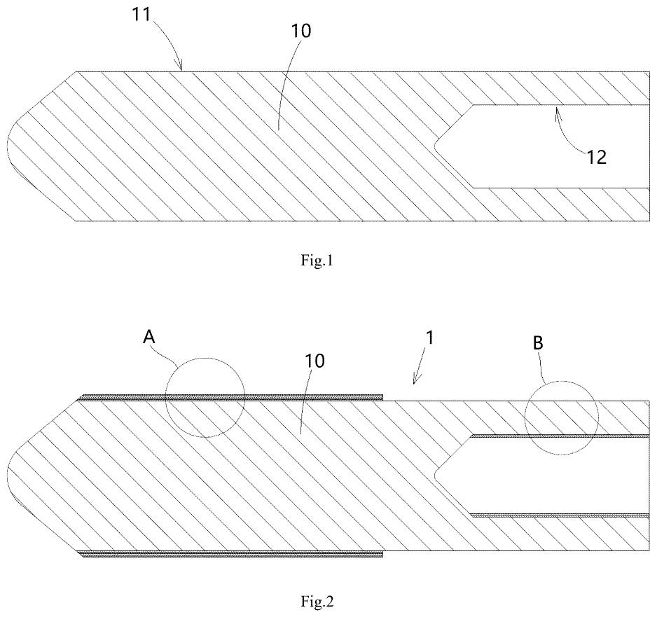

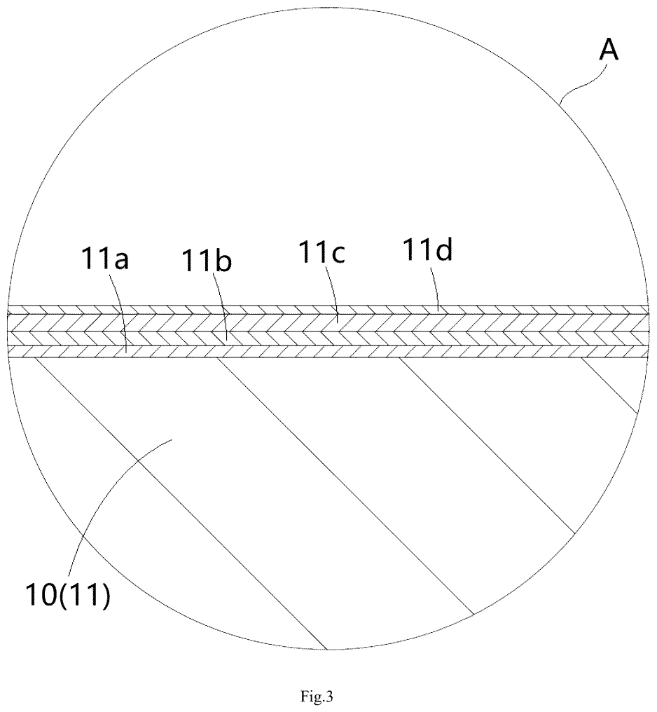

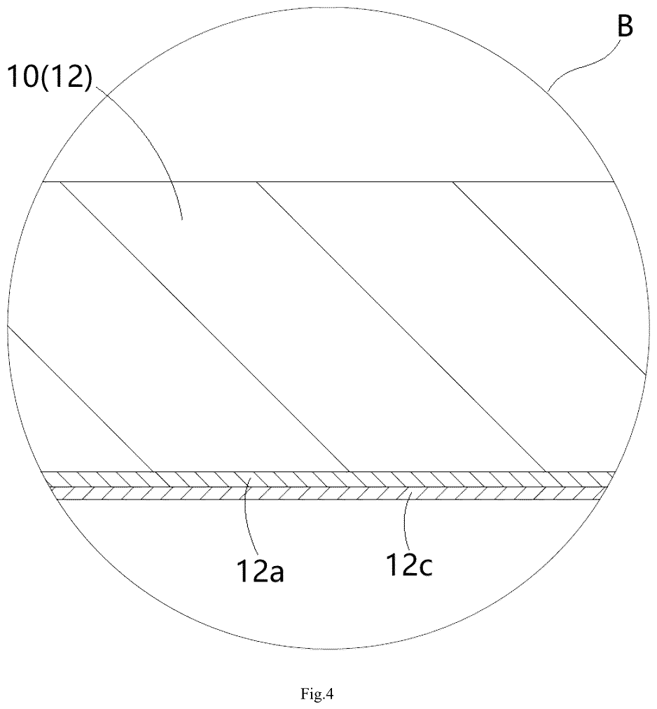

FIGS. 1-5 show the first embodiment according to the present invention. Among them, FIG. 1 shows an illustrative view of the terminal body 10 according to the first embodiment of the present invention; FIG. 2 shows an illustrative view of terminal 1 according to the first embodiment of the present invention; FIG. 3 shows an enlarged illustrative view of part A of the mating part 11 of terminal 1 according to the first embodiment of the present invention; FIG. 4 shows an enlarged illustrative view of part B of the crimping part 12 of terminal 1 according to the first embodiment of the present invention; FIG. 5 shows an illustrative view of terminal 1, mating terminal 2, and cable conductor 3 according to the first embodiment of the present invention, where the mating part 11 of terminal 1 is mated with mating terminal 2, and the crimping part 12 of terminal 1 is crimped onto cable conductor 3.

As shown in FIGS. 1-5, in an exemplary embodiment of the present invention, a terminal 1 is disclosed. The terminal 1 includes a terminal body 10. The terminal body 10 has a mating part 11 for mating with a mating terminal 2. A first bottom plating layer 11a is formed on the contact surface of the mating part 11 of the terminal body 10, and a first silver alloy plating layer 11b is formed on the first bottom plating layer 11a. For example, the first silver alloy plating layer 11b may be a silver antimony (AgSb) alloy plating layer. A first silver graphite plating layer (or referred to as a first Ag—C plating layer) 11c is formed on the first silver alloy plating layer 11b, and a second silver alloy plating layer 11d is formed on the first silver graphite plating layer 11c. For example, the second silver alloy plating layer 11d may be a silver antimony alloy plating layer.

In the illustrated embodiment, graphite particles are uniformly dispersed in the first silver graphite plating layer 11c, thereby improving the wear resistance and conductivity of the mating part 11 of terminal 1, and reducing the insertion resistance between the mating part 11 of terminal 1 and the mating terminal 2. In one embodiment, the Ag content of the first silver graphite plating layer 11c is greater than 99% by weight, and the thickness of the first silver graphite plating layer 11c is 1-5 μm.

In an exemplary embodiment of the present invention, the terminal body 10 is a copper component and serves as the substrate for electroplating the first bottom plating layer 11a. The first bottom plating layer 11a is a nickel plating layer and has a thickness of 1-5 μm. In another exemplary embodiment of the present invention, the terminal body 10 is a copper component and serves as the substrate for electroplating the first bottom plating layer 11a. The first bottom plating layer 11a is a silver plating layer and has a thickness of 0.1˜0.5 μm. In another exemplary embodiment of the present invention, the terminal body 10 is made of aluminum and serves as the substrate for electroplating the first bottom plating layer 11a. The first bottom plating layer 11a is a copper plating layer and has a thickness of 1-3 μm. In another exemplary embodiment of the present invention, the terminal body 10 is made of aluminum and serves as the substrate for electroplating the first bottom plating layer 11a. The first bottom plating layer 11a is a nickel plating layer and has a thickness of 1-5 μm. In another exemplary embodiment of the present invention, the terminal body 10 is made of aluminum and serves as the substrate for electroplating the first bottom plating layer 11a. The first bottom plating layer 11a is a silver plating layer and has a thickness of 0.1˜0.5 μm. In another exemplary embodiment of the present invention, the thickness of the first silver alloy plating layer 11b is 1-8 μm, and the thickness of the second silver alloy plating layer 11d is not less than 1 μm.

As shown in FIGS. 1-5, in the illustrated embodiment, the terminal body 10 also has a crimping part 12 for crimping onto a cable conductor 3. A second bottom plating layer 12a is formed on the contact surface of the crimping part 12 with the cable conductor 3 and a second silver graphite plating layer 12c is formed on the second bottom plating layer 12a. Graphite particles are uniformly dispersed in the second silver graphite plating layer 12c to improve the wear resistance and conductivity of the crimping part 12 of the terminal body 10.

In the illustrated embodiment, the Ag content of the first silver graphite plating layer 11c and the second silver graphite plating layer 12c is greater than 99%. The thickness of the first silver graphite plating layer 11c is 1-5 μm, and the thickness of the second silver graphite plating layer 12c is not less than 1 μm and not greater than the thickness of the first silver graphite plating layer 11c

In an exemplary embodiment of the present invention, the terminal body 10 is a copper component, and serves as a substrate for electroplating the first and second bottom plating layers 11a and 12a. The first and second bottom plating layers 11a and 12a are nickel plating layers, and the thickness of the first and second bottom plating layers 11a and 12a is 1-5 μm. In another exemplary embodiment of the present invention, the terminal body 10 is a copper component, and serves as a substrate for electroplating the first and second bottom plating layers 11a and 12a. The first and second bottom plating layers 11a and 12a are silver plating layers, and the thickness of the first and second bottom plating layers 11a and 12a is 0.1˜0.5 μm. In another exemplary embodiment of the present invention, the terminal body 10 is an aluminum component, and serves as a substrate for electroplating the first and second bottom plating layers 11a and 12a. The first and second bottom plating layers 11a and 12a are copper plating layers, and the thickness of the first and second bottom plating layers 11a and 12a is 1-3 μm. In another exemplary embodiment of the present invention, the terminal body 10 is an aluminum component, and serves as a substrate for electroplating the first and second bottom plating layers 11a and 12a. The first and second bottom plating layers 11a and 12a are nickel plating layers, and the thickness of the first and second bottom plating layers 11a and 12a is 1-5 μm. In another exemplary embodiment of the present invention, the terminal body 10 is an aluminum component, and serves as a substrate for electroplating the first and second bottom plating layers 11a and 12a. The first and second bottom plating layers 11a and 12a are silver plating layers, and the thickness of the first and second bottom plating layers 11a and 12a is 0.1˜0.5 μm.

As shown in FIGS. 1-5, in another exemplary embodiment of the present invention, a terminal manufacturing method is also disclosed. The terminal manufacturing method includes the following steps:
S11: providing a terminal body 10;
S12: A first bottom plating layer 11a is formed on the contact surface of the mating part 11 of the terminal body 10 for mating with a mating terminal 2;
S13: A first silver alloy plating layer 11b is formed on the first bottom plating layer 11a;
S14: A first silver graphite plating layer 11c is formed on the first silver alloy plating layer 11b; and
S15: A second silver alloy plating layer 11d is formed on the first silver graphite plating layer 11c.

As shown in FIGS. 1-5, in the illustrated embodiment, step S12 further comprises forming a second bottom plating layer 12a on the contact surface of the crimping part 12 of the terminal body 10 for crimping onto the cable conductor 3. Step S14 further comprises forming a second silver graphite plating layer 12c on the second bottom plating layer 12a.

As shown in FIGS. 1-5, in the illustrated embodiment, the aforementioned terminal manufacturing method further includes: after step S15, ultrasonic cleaning is performed on the terminal 1, and after cleaning, the terminal 1 is dried and subjected to anti-oxidation treatment.

In the aforementioned embodiments, the silver graphite (Ag—C) plating layer not only possesses all the characteristics of pure silver plating layer, but also can obtain chemical and mechanical properties that pure silver plating layer cannot obtain, thereby greatly reducing the insertion and removal resistance of terminals. In addition, the silver graphite plating layer is non brittle and has higher wear resistance and conductivity than pure silver plating layer. At the same time, it is maintenance free and self-lubricating, improving efficiency and reducing costs. The appearance color is black gray.

### SECOND EMBODIMENT

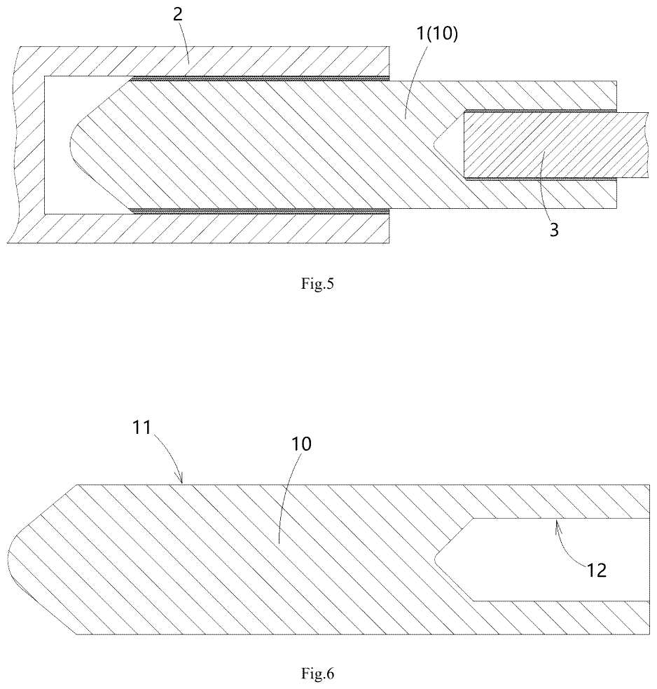

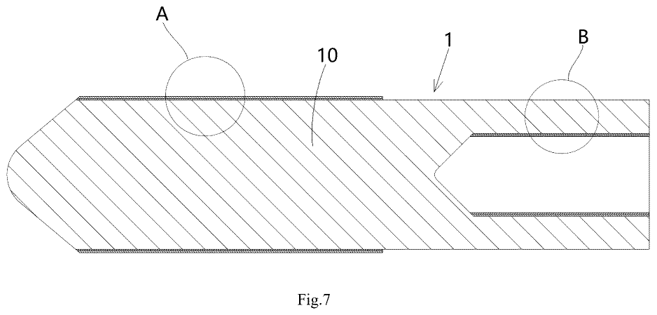

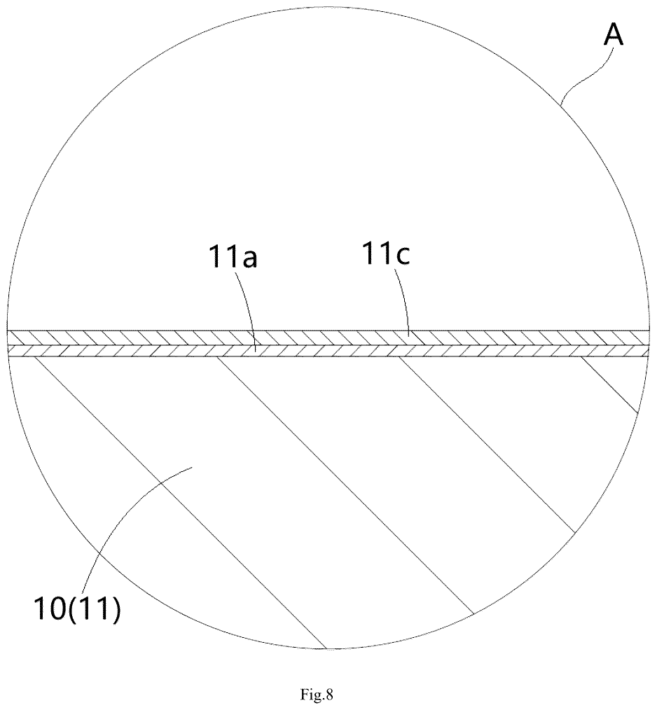

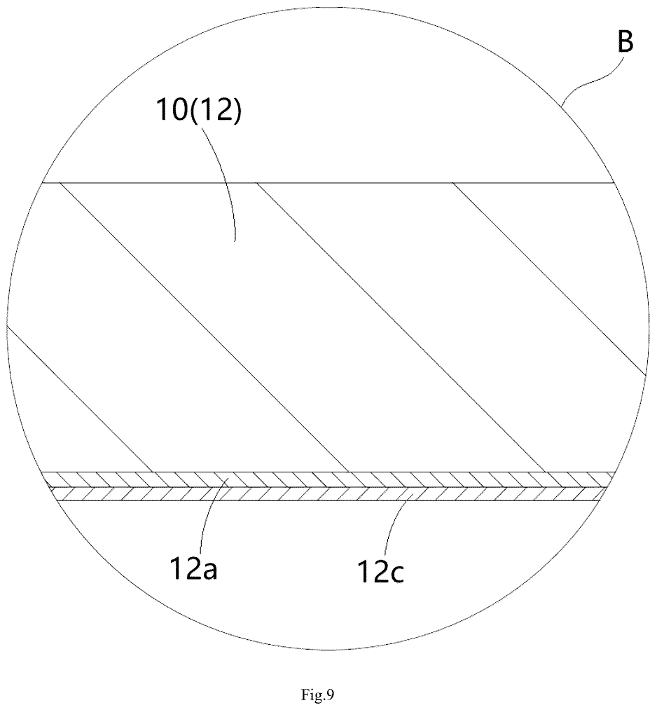

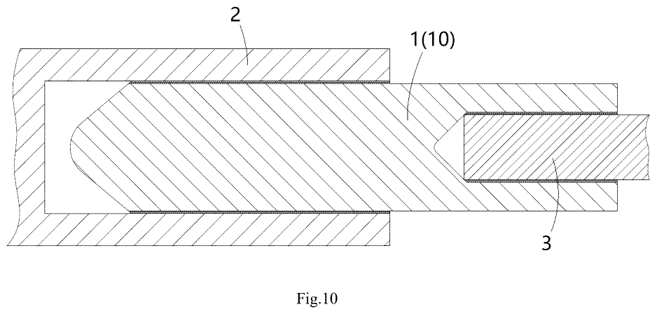

FIGS. 6-10 show a second embodiment according to the present invention. Among them, FIG. 6 shows an illustrative view of the terminal body 10 according to the second embodiment of the present invention; FIG. 7 shows an illustrative view of terminal 1 according to the second embodiment of the present invention; FIG. 8 shows an enlarged illustrative view of part A of the mating part 11 of terminal 1 according to the second embodiment of the present invention; FIG. 9 shows an enlarged illustrative view of part B of the crimping part 12 of terminal 1 according to the second embodiment of the present invention; FIG. 10 shows an illustrative view of terminal 1, mating terminal 2, and cable conductor 3 according to the second embodiment of the present invention, where the mating part 11 of terminal 1 is mated with mating terminal 2, and the crimping part 12 of terminal 1 is crimped onto cable conductor 3.

As shown in FIGS. 6-10, in an exemplary embodiment of the present invention, a terminal 1 is also disclosed. The terminal 1 includes a terminal body 10. The terminal body 10 has a mating part 11 for mating with a mating terminal 2. A first bottom plating layer 11a is formed on the contact surface of the mating part 11 of the terminal body 10 and a first silver graphite plating layer 11c is formed on the first bottom plating layer 11a. Graphite particles are uniformly dispersed in the first silver graphite plating layer 11c to improve the wear resistance and conductivity of the mating part 11 of the terminal 1. In the illustrated embodiment, the Ag content of the first silver graphite plating layer 11c is greater than 99%. The thickness of the first silver graphite plating layer 11c is 1-5 μm.

As shown in FIGS. 6-10, in an exemplary embodiment of the present invention, the terminal body 10 is a copper component and serves as the substrate for electroplating the first bottom plating layer 11a. The first bottom plating layer 11a is a nickel plating layer and has a thickness of 1-5 μm. In another exemplary embodiment of the present invention, the terminal body 10 is a copper component and serves as the substrate for electroplating the first bottom plating layer 11a. The first bottom plating layer 11a is a silver plating layer and has a thickness of 0.1˜0.5 μm. [symbol] another exemplary embodiment of the present invention, the terminal body 10 is made of aluminum and serves as the substrate for electroplating the first bottom plating layer 11a. The first bottom plating layer 11a is a copper plating layer and has a thickness of 1-3 μm. In another exemplary embodiment of the present invention, the terminal body 10 is made of aluminum and serves as the substrate for electroplating the first bottom plating layer 11a. The first bottom plating layer 11a is a nickel plating layer and has a thickness of 1-5 μm. In another exemplary embodiment of the present invention, the terminal body 10 is made of aluminum and serves as the substrate for electroplating the first bottom plating layer 11a. The first bottom plating layer 11a is a silver plating layer and has a thickness of 0.1˜0.5 μm.

As shown in FIGS. 6-10, in another exemplary embodiment of the present invention, the terminal body 10 further has a crimping part 12 for crimping onto the cable conductor 3. A second bottom plating layer 12a is formed on the contact surface of the crimping part 12 with the cable conductor 3, and a second silver graphite plating layer 12c is formed on the second bottom plating layer 12a. Graphite particles are uniformly dispersed in the second silver graphite plating layer 12c to improve the wear resistance and conductivity of the crimping part 12 of the terminal body 10.

As shown in FIGS. 6-10, in another exemplary embodiment of the present invention, the Ag content of the first silver graphite plating layer 11c and the second silver graphite plating layer 12c is greater than 99%. In another exemplary embodiment of the present invention, the thickness of the first silver graphite plating layer 11c is 1-5 μm, and the thickness of the second silver graphite plating layer 12c is not less than 1 μm and not greater than the thickness of the first silver graphite plating layer 11c

As shown in FIGS. 6-10, in another exemplary embodiment of the present invention, the terminal body 10 is a copper component, and serves as a substrate for electroplating the first and second bottom plating layers 11a and 12a. The first and second bottom plating layers 11a and 12a are nickel plating layers, and the thickness of the first and second bottom plating layers 11a and 12a is 1-5 μm. In another exemplary embodiment of the present invention, the terminal body 10 is a copper component, and serves as a substrate for electroplating the first and second bottom plating layers 11a and 12a. The first and second bottom plating layers 11a and 12a are silver plating layers, and the thickness of the first and second bottom plating layers 11a and 12a is 0.1˜0.5 μm. In another exemplary embodiment of the present invention, the terminal body 10 is an aluminum component, and serves as a substrate for electroplating the first and second bottom plating layers 11a and 12a. The first and second bottom plating layers 11a and 12a are copper plating layers, and the thickness of the first and second bottom plating layers 11a and 12a is 1-3 μm. In another exemplary embodiment of the present invention, the terminal body 10 is an aluminum component, and serves as a substrate for electroplating the first and second bottom plating layers 11a and 12a. The first and second bottom plating layers 11a and 12a are nickel plating layers, and the thickness of the first and second bottom plating layers 11a and 12a is 1-5 μm. In another exemplary embodiment of the present invention, the terminal body 10 is an aluminum component, and serves as a substrate for electroplating the first and second bottom plating layers 11a and 12a. The first and second bottom plating layers 11a and 12a are silver plating layers, and the thickness of the first and second bottom plating layers 11a and 12a is 0.1˜0.5 μm.

As shown in FIGS. 6-10, in another exemplary embodiment of the present invention, a terminal manufacturing method is also disclosed. The terminal manufacturing method includes the following steps:
S21: providing a terminal body 10;
S22: A first bottom plating layer 11a is formed on the contact surface of the mating part 11 of the terminal body 10 for mating with the mating terminal 2; and
S23: A first silver graphite plating layer 11c is formed on the first silver alloy plating layer 11b.

As shown in FIGS. 6-10, in the illustrated embodiment, step S22 further comprises forming a second bottom plating layer 12a on the contact surface of the crimping part 12 of the terminal body 10 for crimping onto the cable conductor 3. Step S23 further comprises forming a second silver graphite plating layer 12c on the second bottom plating layer 12a.

In the illustrated embodiment, the aforementioned terminal manufacturing method further includes: after step S23, ultrasonic cleaning is performed on terminal 1, and after cleaning, the terminal 1 is dried and subjected to anti-oxidation treatment.

In the aforementioned embodiments, the silver graphite (Ag—C) plating layer not only possesses all the characteristics of pure silver plating layer, but also can obtain chemical and mechanical properties that pure silver plating layer cannot obtain, thereby greatly reducing the insertion and removal resistance of terminals. In addition, the silver graphite plating layer is non brittle and has higher wear resistance and conductivity than pure silver plating layer. At the same time, it is maintenance free and self-lubricating, improving efficiency and reducing costs. The appearance color is black gray.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a terminal body including a mating part adapted to mate with a mating terminal;
a first bottom plating layer formed on a contact surface of the mating part of the terminal body; and
a first silver graphite plating layer formed on the first bottom plating layer, wherein graphite particles are uniformly dispersed in the first silver graphite plating layer and adapted to improve the wear resistance and conductivity of the mating part of the terminal body.

2. The terminal according to claim 1, wherein the first silver graphite plating layer has an Ag content greater than 99%.

3. The terminal according to claim 1, wherein the thickness of the first silver graphite plating layer is 1˜5 μm.

4. The terminal according to claim 1, wherein:
the terminal body is a copper component and defines a substrate for electroplating the first bottom plating layer; and
the first bottom plating layer is a nickel plating layer and has a thickness of 1˜5 μm.

5. The terminal according to claim 1, wherein:
the terminal body is a copper component and defines a substrate for electroplating the first bottom plating layer; and
the first bottom plating layer is a silver plating layer and has a thickness of 0.1˜0.5 μm.

6. The terminal according to claim 1, wherein:
the terminal body is made of aluminum and defines a substrate for electroplating the first bottom plating layer; and
the first bottom plating layer is a copper plating layer and has a thickness of 1˜3 μm.

7. The terminal according to claim 1, wherein:
the terminal body is made of aluminum and defines a substrate for electroplating the first bottom plating layer; and
the first bottom plating layer is a nickel plating layer and has a thickness of 1˜5 μm.

8. The terminal according to claim 1, wherein:
the terminal body is made of aluminum and defines a substrate for electroplating the first bottom plating layer; and
the first bottom plating layer is a silver plating layer and has a thickness of 0.1˜0.5 μm.

9. The terminal according to claim 1, wherein the terminal further includes a first silver alloy plating layer formed between the first bottom plating layer and the first silver graphite plating layer, and the first silver alloy plating layer has a thickness of 1˜8 μm.

10. The terminal according to claim 9, wherein the terminal further includes a second silver alloy plating layer formed on the first silver graphite plating layer, and the thickness of the second silver alloy plating layer is not less than 1 μm.

11. The terminal according to claim 1, wherein:
the terminal body includes a crimping part adapted to crimp onto a cable conductor, and a second bottom plating layer is formed on the contact surface of the crimping part with the cable conductor, and a second silver graphite plating layer is formed on the second bottom plating layer; and
graphite particles are uniformly dispersed in the second silver graphite plating layer and adapted to improve the wear resistance and conductivity of the crimping part of the terminal body.

12. The terminal according to claim 11, wherein the first silver graphite plating layer and the second silver graphite plating layer have an Ag content greater than 99%.

13. The terminal according to claim 11, wherein the thickness of the first silver graphite plating layer is 1˜5 μm, and the thickness of the second silver graphite plating layer is not less than 1 μm and not greater than the thickness of the first silver graphite plating layer.

14. The terminal according to claim 11, wherein:
the terminal body is a copper component and defines a substrate for electroplating the first and second bottom plating layers; and
the first and second bottom plating layers are nickel plating layers, and the thickness of the first and second bottom plating layers is 1˜5 μm.

15. The terminal according to claim 11, wherein:
the terminal body is a copper component and defines a substrate for electroplating the first and second bottom plating layers; and
the first and second bottom plating layers are silver plating layers, and the thickness of the first and second bottom plating layers is 0.1˜0.5 μm.

16. The terminal according to claim 11, wherein:
the terminal body is an aluminum component and defines a substrate for electroplating the first and second bottom plating layers; and
the first and second bottom plating layers are copper plating layers, and the thickness of the first and second bottom plating layers is 1˜3 μm.

17. The terminal according to claim 11, wherein:
the terminal body is an aluminum component and defines a substrate for electroplating the first and second bottom plating layers; and
the first and second bottom plating layers are nickel plating layers, and the thickness of the first and second bottom plating layers is 1˜5 μm.

18. The terminal according to claim 11, wherein:
the terminal body is an aluminum component and defines a substrate for electroplating the first and second bottom plating layers; and
the first and second bottom plating layers are silver plating layers, and the thickness of the first and second bottom plating layers is 0.1˜0.5 μm.

19. A terminal manufacturing method, comprising the steps of:
providing a terminal body;
forming a first bottom plating layer on a contact surface of a mating part of the terminal body for mating with a mating terminal;
forming a first silver alloy plating layer on the first bottom plating layer;
forming a first silver graphite plating layer on the first silver alloy plating layer; and
forming a second silver alloy plating layer on the first silver graphite plating layer.

20. The terminal manufacturing method according to claim 19, wherein:
the step of forming a first bottom plating layer further includes forming a second bottom plating layer on a contact surface of a crimping part of the terminal body for crimping onto a cable conductor; and
the step of forming the first silver graphite plating layer further includes forming a second silver graphite plating layer on the second bottom plating layer.

21. The terminal manufacturing method according to claim 19, further comprising, after the step of forming the second silver alloy plating layer, the terminal is subjected to ultrasonic cleaning and then dried and treated with anti-oxidation after cleaning.

22. A terminal manufacturing method, comprising the steps of:
S21: providing a terminal body;
S22: forming a first bottom plating layer on a contact surface of a mating part of the terminal body for mating with a mating terminal; and
S23: forming a first silver graphite plating layer on the first silver alloy plating layer.

23. The terminal manufacturing method according to claim 22, wherein:
the step of forming the first bottom plating layer further includes forming a second bottom plating layer on a contact surface of a crimping part of the terminal body for crimping onto a cable conductor; and
the step of forming the first silver graphite plating layer further includes forming a second silver graphite plating layer on the second bottom plating layer.

24. The terminal manufacturing method according to claim 22, further comprising, after the step of forming the first silver graphite plating layer, the terminal is subjected to ultrasonic cleaning and then dried and treated with anti-oxidation after cleaning.
